(19) United States
(12) Patent Application Publication
(10) Pub. No.: US 2025/0049137 A1
(43) Pub. Date: Feb. 13, 2025

(54) REAL-TIME TEMPERATURE CONTROL FOR AN AEROSOL DELIVERY DEVICE

(71) Applicant: RAI Strategic Holdings, Inc., Winston-Salem, NC (US)

(72) Inventors: Michael F. Davis, Clemmons, NC (US); Balager Ademe, Winston-Salem, NC (US); Percy D. Phillips, Pfafftown, NC (US)

(21) Appl. No.: 18/930,699

(22) Filed: Oct. 29, 2024

Related U.S. Application Data
(63) Continuation of application No. 15/349,619, filed on Nov. 11, 2016, now abandoned.

(51) Int. Cl. A24F 40/50; A24F 40/10; A24F 40/60; H05B 1/02

(52) U.S. Cl. CPC A24F 40/50; A24F 40/60; H05B 1/0244; A24F 40/10; H05B 2203/021

(57) ABSTRACT

An aerosol delivery device is provided that comprises a housing equipped with a heating element, a resistance temperature detector (RTD) and a control component. The housing may contain an aerosol precursor composition, and the heating element may be controllable to activate and vaporize components of the aerosol precursor composition. The RTD may have a resistance that is variable and proportional to a temperature of the heating element, and may also have a temperature coefficient of resistance that is suitably large enough and invariable with respect to the temperature of the heating element. The control component may be configured to measure the resistance of the RTD and therefrom determine the temperature of the heating element, and control at least one functional element in real time based on the temperature so determined, including output of the temperature for presentation by a display, or adjustment of the power to the heating element.

### CROSS-REFERENCE TO RELATED APPLICATIONS

This application claims priority to U.S. patent application Ser. No. 15/349,619; filed Nov. 11, 2016, the disclosure of which is hereby incorporated by reference in its entirety.

### TECHNOLOGICAL FIELD

The present disclosure relates to aerosol delivery devices such as smoking articles, and more particularly to aerosol delivery devices that may utilize electrically generated heat for the production of aerosol (e.g., smoking articles commonly referred to as electronic cigarettes). The smoking articles may be configured to heat an aerosol precursor, which may incorporate materials that may be made or derived from, or otherwise incorporate tobacco, the precursor being capable of forming an inhalable substance for human consumption.

### BACKGROUND

Many smoking devices have been proposed through the years as improvements upon, or alternatives to, smoking products that require combusting tobacco for use. Many of those devices purportedly have been designed to provide the sensations associated with cigarette, cigar or pipe smoking, but without delivering considerable quantities of incomplete combustion and pyrolysis products that result from the burning of tobacco. To this end, there have been proposed numerous smoking products, flavor generators and medicinal inhalers that utilize electrical energy to vaporize or heat a volatile material, or attempt to provide the sensations of cigarette, cigar or pipe smoking without burning tobacco to a significant degree. See, for example, the various alternative smoking articles, aerosol delivery devices and heat generating sources set forth in the background art described in U.S. Pat. No. 7,726,320 to Robinson et al. and U.S. Pat. No. 8,881,737 to Collett et al., which are incorporated herein by reference. See also, for example, the various types of smoking articles, aerosol delivery devices and electrically-powered heat generating sources referenced by brand name and commercial source in U.S. Pat. Pub. No. 2015/0216232 to Bless et al., which is incorporated herein by reference. Additionally, various types of electrically powered aerosol and vapor delivery devices also have been proposed in U.S. Pat. Pub. No. 2014/0096781 to Sears et al. and U.S. Pat. Pub. No. 2014/0283859 to Minskoff et al., as well as U.S. patent application Ser. No. 14/282,768 to Sears et al., filed May 20, 2014; Ser. No. 14/286,552 to Brinkley et al., filed May 23, 2014; Ser. No. 14/327,776 to Ampolini et al., filed Jul. 10, 2014; and Ser. No. 14/465,167 to Worm et al., filed Aug. 21, 2014; all of which are incorporated herein by reference.

It would be desirable to provide a means for implementing real-time temperature control of aerosol delivery devices.

### BRIEF SUMMARY

The present disclosure relates to aerosol delivery devices, methods of forming such devices, and elements of such devices. The present disclosure includes, without limitation, the following example implementations. In some example implementations, an aerosol delivery device is provided. The aerosol delivery device may comprise at least one housing containing an aerosol precursor composition and equipped with a heating element, a resistance temperature detector (RTD), and a control component. The heating element may be controllable to activate and vaporize components of the aerosol precursor composition. The RTD may have a resistance that is variable and proportional to a temperature of the heating element, and a temperature coefficient of resistance that is invariable with respect to the temperature of the heating element.

The control component may be configured to direct power to the heating element to activate and vaporize components of the aerosol precursor composition. The control component may also be configured to measure the resistance of the RTD and therefrom determine the temperature of the heating element, and control at least one functional element in real time based on the temperature so determined. Control of the at least one functional element may include output of the temperature for presentation by a display, or adjustment of the power to the heating element.

In some example implementations of the aerosol delivery device of the preceding or any subsequent example implementation, or any combination thereof, the RTD is integrated with the heating element and includes an RTD element configured to produce heat to vaporize components of the aerosol precursor composition.

In some example implementations of the aerosol delivery device of any preceding or any subsequent example implementation, or any combination thereof, the RTD is formed of an element including platinum (Pt), titanium (Ti), copper (Cu) or nickel (Ni), or at least one alloy thereof.

In some example implementations of the aerosol delivery device of any preceding or any subsequent example implementation, or any combination thereof, control of the at least one functional element includes output of the temperature for presentation by the display, and adjustment of the power to the heating element.

In some example implementations of the aerosol delivery device of any preceding or any subsequent example implementation, or any combination thereof, control of the at least one functional element includes output of the temperature for presentation by the display in which the display is a remote display, and the aerosol delivery device further comprises a communication interface coupled to the control component and configured to enable wireless communication of the temperature to the remote display.

In some example implementations of the aerosol delivery device of any preceding or any subsequent example implementation, or any combination thereof, the control component is further configured to receive a temperature-based setting from a user interface, the control component being configured to direct the power to the heating element in accordance with the temperature-based setting.

In some example implementations of the aerosol delivery device of any preceding or any subsequent example implementation, or any combination thereof, the user interface is a remote user interface, and the aerosol delivery device further comprises a communication interface coupled to the control component and configured to enable wireless communication of the temperature-based setting from the remote user interface.

In some example implementations, a cartridge coupled or coupleable with a control body to form an aerosol delivery device is provided in which the control body may be equipped with a control component. The cartridge may comprise a housing defining a reservoir configured to retain aerosol precursor composition, a heating element and a resistance temperature detector (RTD). The heating element may be configured to operate in an active mode in which the cartridge is coupled with the control body, and the heating element in the active mode is controllable by the control component to activate and vaporize components of the aerosol precursor composition.

The RTD may have a resistance that is variable and proportional to a temperature of the heating element, and a temperature coefficient of resistance that is invariable with respect to the temperature of the heating element. The resistance of the RTD is measurable by the control component in which the control component may be configured to measure the resistance of the RTD and therefrom determine the temperature of the heating element, and control at least one functional element in real time based on the temperature so determined, control of the at least one functional element including output of the temperature for presentation by a display, or adjustment of the power to the heating element.

In some example implementations of the cartridge of the preceding or any subsequent example implementation, or any combination thereof, the RTD is integrated with the heating element and includes an RTD element configured to produce heat to vaporize components of the aerosol precursor composition.

In some example implementations of the cartridge of any preceding or any subsequent example implementation, or any combination thereof, the RTD is formed of an element including platinum (Pt), titanium (Ti), copper (Cu) or nickel (Ni), or at least one alloy thereof.

In some example implementations of the cartridge of any preceding or any subsequent example implementation, or any combination thereof, control of the at least one functional element includes output of the temperature for presentation by the display, and adjustment of the power to the heating element.

In some example implementations of the cartridge of any preceding or any subsequent example implementation, or any combination thereof, control of the at least one functional element includes output of the temperature for presentation by the display in which the display is a remote display, and the aerosol delivery device further comprises a communication interface coupled to the control component and configured to enable wireless communication of the temperature to the remote display.

In some example implementations of the cartridge of any preceding or any subsequent example implementation, or any combination thereof, the control component is further configured to receive a temperature-based setting from a user interface, the control component being configured to direct the power to the heating element in accordance with the temperature-based setting.

In some example implementations of the cartridge of any preceding or any subsequent example implementation, or any combination thereof, the user interface is a remote user interface, and the aerosol delivery device further comprises a communication interface coupled to the control component and configured to enable wireless communication of the temperature-based setting from the remote user interface.

In some example implementations, a control body coupled or coupleable with a cartridge to form an aerosol delivery device is provided. The cartridge contains an aerosol precursor composition, and is equipped with a heating element and a resistance temperature detector (RTD). The RTD may have a resistance that is variable and proportional to a temperature of the heating element, and a temperature coefficient of resistance that is invariable with respect to the temperature of the heating element.

The control body may comprise a control component configured to direct power to the heating element to activate and vaporize components of the aerosol precursor composition. The control component may also be configured to measure the resistance of the RTD and therefrom determine the temperature of the heating element, and control at least one functional element in real time based on the temperature so determined. Control of the at least one functional element may include output of the temperature for presentation by a display, or adjustment of the power to the heating element.

In some example implementations of the control body of the preceding or any subsequent example implementation, or any combination thereof, the RTD is integrated with the heating element and includes an RTD element configured to produce heat to vaporize components of the aerosol precursor composition.

In some example implementations of the control body of any preceding or any subsequent example implementation, or any combination thereof, the RTD is formed of an element including platinum (Pt), titanium (Ti), copper (Cu) or nickel (Ni), or at least one alloy thereof.

In some example implementations of the control body of any preceding or any subsequent example implementation, or any combination thereof, control of the at least one functional element includes output of the temperature for presentation by the display, and adjustment of the power to the heating element.

In some example implementations of the control body of any preceding or any subsequent example implementation, or any combination thereof, control of the at least one functional element includes output of the temperature for presentation by the display in which the display is a remote display, and the aerosol delivery device further comprises a communication interface coupled to the control component and configured to enable wireless communication of the temperature to the remote display.

In some example implementations of the control body of any preceding or any subsequent example implementation, or any combination thereof, the control component is further configured to receive a temperature-based setting from a user interface, the control component being configured to direct the power to the heating element in accordance with the temperature-based setting.

In some example implementations of the control body of any preceding or any subsequent example implementation, or any combination thereof, the user interface is a remote user interface, and the aerosol delivery device further comprises a communication interface coupled to the control component and configured to enable wireless communication of the temperature-based setting from the remote user interface.

These and other features, aspects, and advantages of the present disclosure will be apparent from a reading of the following detailed description together with the accompanying drawings, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and example implementations, should be viewed as intended, namely to be combinable, unless the context of the disclosure clearly dictates otherwise.

It will therefore be appreciated that this Brief Summary is provided merely for purposes of summarizing some example implementations so as to provide a basic understanding of some aspects of the disclosure. Accordingly, it will be appreciated that the above described example implementations are merely examples and should not be construed to narrow the scope or spirit of the disclosure in any way. Other example implementations, aspects and advantages will become apparent from the following detailed description taken in conjunction with the accompanying drawings which illustrate, by way of example, the principles of some described example implementations.

### BRIEF DESCRIPTION OF THE DRAWING(S)

Having thus described the disclosure in the foregoing general terms, reference will now be made to the accompanying drawings, which are not necessarily drawn to scale, and wherein:

FIG. 1 illustrates a front view of an aerosol delivery device including a housing having a cartridge therein, according to an example implementation of the present disclosure;

FIG. 2 schematically illustrates a sectional view through the aerosol delivery device of FIG. 1, according to an example implementation of the present disclosure;

FIG. 3 illustrates an exploded view of a cartridge suitable for use in the aerosol delivery device of FIG. 1, according to an example implementation of the present disclosure;

FIG. 4 illustrates a perspective view of the aerosol delivery device of FIG. 1, according to an example implementation of the present disclosure;

FIG. 5 illustrates an opposing perspective view of the aerosol delivery device of FIG. 1, according to an example implementation of the present disclosure; and

FIGS. 6A and 6B illustrate various components of the aerosol delivery device of FIG. 1 including a resistance temperature detector (RTD), according to some example implementations.

### DETAILED DESCRIPTION

The present disclosure will now be described more fully hereinafter with reference to example implementations thereof. These example implementations are described so that this disclosure will be thorough and complete, and will fully convey the scope of the disclosure to those skilled in the art. Indeed, the disclosure may be embodied in many different forms and should not be construed as limited to the implementations set forth herein; rather, these implementations are provided so that this disclosure will satisfy applicable legal requirements. As used in the specification and the appended claims, the singular forms “a,” “an,” “the” and the like include plural referents unless the context clearly dictates otherwise.

As described hereinafter, example implementations of the present disclosure relate to aerosol delivery systems. Aerosol delivery systems according to the present disclosure use electrical energy to heat a material (preferably without combusting the material to any significant degree) to form an inhalable substance; and components of such systems have the form of articles most preferably are sufficiently compact to be considered hand-held devices. That is, use of components of preferred aerosol delivery systems does not result in the production of smoke in the sense that aerosol results principally from by-products of combustion or pyrolysis of tobacco, but rather, use of those preferred systems results in the production of vapors resulting from volatilization or vaporization of certain components incorporated therein. In some example implementations, components of aerosol delivery systems may be characterized as electronic cigarettes, and those electronic cigarettes most preferably incorporate tobacco and/or components derived from tobacco, and hence deliver tobacco derived components in aerosol form.

Aerosol generating pieces of certain preferred aerosol delivery systems may provide many of the sensations (e.g., inhalation and exhalation rituals, types of tastes or flavors, organoleptic effects, physical feel, use rituals, visual cues such as those provided by visible aerosol, and the like) of smoking a cigarette, cigar or pipe that is employed by lighting and burning tobacco (and hence inhaling tobacco smoke), without any substantial degree of combustion of any component thereof. For example, the user of an aerosol generating piece of the present disclosure can hold and use that piece much like a smoker employs a traditional type of smoking article, draw on one end of that piece for inhalation of aerosol produced by that piece, take or draw puffs at selected intervals of time, and the like.

Aerosol delivery systems of the present disclosure also can be characterized as being vapor-producing articles or medicament delivery articles. Thus, such articles or devices can be adapted so as to provide one or more substances (e.g., flavors and/or pharmaceutical active ingredients) in an inhalable form or state. For example, inhalable substances can be substantially in the form of a vapor (i.e., a substance that is in the gas phase at a temperature lower than its critical point). Alternatively, inhalable substances can be in the form of an aerosol (i.e., a suspension of fine solid particles or liquid droplets in a gas). For purposes of simplicity, the term “aerosol” as used herein is meant to include vapors, gases and aerosols of a form or type suitable for human inhalation, whether or not visible, and whether or not of a form that might be considered to be smoke-like.

Aerosol delivery systems of the present disclosure generally include a number of components provided within an outer body or shell, which may be referred to as a housing. The overall design of the outer body or shell can vary, and the format or configuration of the outer body that can define the overall size and shape of the aerosol delivery device can vary. Aerosol delivery devices are often configured in a manner that mimics aspects of certain traditional smoking devices such as cigarettes or cigars. In this regard, aerosol delivery devices typically define a substantially cylindrical configuration. Typically, an elongated body resembling the shape of a cigarette or cigar can be a formed from a single, unitary housing or the elongated housing can be formed of two or more separable bodies. For example, an aerosol delivery device can comprise an elongated shell or body that can be substantially tubular in shape and, as such, resemble the shape of a conventional cigarette or cigar. Aerosol delivery devices often include a control body and a cartridge which attach in an end-to-end relationship to define the substantially cylindrical configuration.

While such configurations may provide a look and feel that is similar to traditional smoking articles, these configurations may suffer from certain detriments. For example, cylindrically-configured aerosol delivery devices may not define attachment points usable to retain the aerosol delivery device in a desired position when not in use. Further, the cylindrical configuration may result in the mouthpiece being exposed to the surrounding environment and therefore susceptible to contamination. Accordingly, it may be desirable to provide aerosol delivery devices in configurations that differ from shapes associated with traditional smoking articles.

In one example, all of the components of the aerosol delivery device are contained within one housing. Alternatively, an aerosol delivery device can comprise two or more housings that are joined and are separable. For example, an aerosol delivery device can possess at one end a control body comprising a housing containing one or more reusable components (e.g., a rechargeable battery and various electronics for controlling the operation of that article), and at the other end and integral with or removably coupled thereto, an outer body or shell containing a disposable portion (e.g., a disposable flavor-containing cartridge).

Aerosol delivery systems of the present disclosure most preferably comprise some combination of a power source (i.e., an electrical power source), at least one control component (e.g., means for actuating, controlling, regulating and ceasing power for heat generation, such as by controlling electrical current flow the power source to other components of the article—e.g., a microprocessor, individually or as part of a microcontroller), a heater or heat generation member (e.g., an electrical resistance heating element or other component), an aerosol precursor composition (e.g., commonly a liquid capable of yielding an aerosol upon application of sufficient heat, such as ingredients commonly referred to as “smoke juice,” “e-liquid” and “e-juice”), and a mouthend region or tip for allowing draw upon the aerosol delivery device for aerosol inhalation (e.g., a defined airflow path through the article such that aerosol generated can be withdrawn therefrom upon draw). In some implementations, the electrical resisting heating element or other component, alone or in combination with one or more further elements, may be commonly referred to as an “atomizer,” or may be or include a resistance temperature detector (RTD)

In various examples, an aerosol delivery device can comprise a reservoir configured to retain the aerosol precursor composition. The reservoir particularly can be formed of a porous material (e.g., a fibrous material) and thus may be referred to as a porous substrate (e.g., a fibrous substrate).

A fibrous substrate useful as a reservoir in an aerosol delivery device can be a woven or nonwoven material formed of a plurality of fibers or filaments and can be formed of one or both of natural fibers and synthetic fibers. For example, a fibrous substrate may comprise a fiberglass material. In particular examples, a cellulose acetate material can be used. In other example implementations, a carbon material can be used. In further implementations, viscose rayon or regenerated cellulose may be used. A reservoir may be substantially in the form of a container and may include a fibrous material included therein.

In some implementations, the aerosol delivery device can include an indicator, which may comprise one or more light emitting diodes or a graphical user interface via a display. The indicator can be in communication with the control component through a connector circuit and illuminate, for example, during a user draw on the mouthend as detected by the flow sensor.

More specific formats, configurations and arrangements of components within the aerosol delivery systems of the present disclosure will be evident in light of the further disclosure provided hereinafter. Additionally, the selection and arrangement of various aerosol delivery system components can be appreciated upon consideration of the commercially available electronic aerosol delivery devices, such as those representative products referenced in background art section of the present disclosure. Further, the arrangement of the components within the aerosol delivery device can also be appreciated upon consideration of the commercially available electronic aerosol delivery devices. Examples of commercially available products, for which the components thereof, methods of operation thereof, materials included therein, and/or other attributes thereof may be included in the devices of the present disclosure have been marketed as ACCORD® by Philip Morris Incorporated; ALPHA™, JOYE 510™ and M4™ by InnoVapor LLC; CIRRUS™ and FLING™ by White Cloud Cigarettes; BLU™ by Lorillard Technologies, Inc.; COHITA™, COLIBRI™, ELITE CLASSIC™, MAGNUM™, PHANTOM™ and SENSE™ by Epuffer® International Inc.; DUOPRO™, STORM™ and VAPORKING® by Electronic Cigarettes, Inc.; EGAR™ by Egar Australia; cGo-C™ and eGo-T™ by Joyetech; ELUSION™ by Elusion UK Ltd; EONSMOKE® by Eonsmoke LLC; FINT by FIN Branding Group, LLC; SMOKE® by Green Smoke Inc. USA; GREENARETTE™ by Greenarette LLC; HALLIGAN™, HENDU™, JET™, MAXXQ™, PINK™ and PITBULL™ by Smoke Stik®; HEATBAR™ by Philip Morris International, Inc.; HYDRO IMPERIAL™ and LXE™ from Crown7; LOGIC™ and THE CUBAN™ by LOGIC Technology; LUCI® by Luciano Smokes Inc.; METRO® by Nicotek, LLC; NJOY® and ONEJOY™ by Sottera, Inc.; NO. 7™ by SS Choice LLC; PREMIUM ELECTRONIC CIGARETTE™ by PremiumEstore LLC; RAPP E-MYSTICK™ by Ruyan America, Inc.; RED DRAGON™ by Red Dragon Products, LLC; RUYAN® by Ruyan Group (Holdings) Ltd.; SF® by Smoker Friendly International, LLC; GREEN SMART SMOKER® by The Smart Smoking Electronic Cigarette Company Ltd.; SMOKE ASSIST® by Coastline Products LLC; SMOKING EVERYWHERE® by Smoking Everywhere, Inc.; V2CIGS™ by VMR Products LLC; VAPOR NINE™ by VaporNine LLC; VAPOR4LIFE® by Vapor 4 Life, Inc.; VEPPO™ by E-CigaretteDirect, LLC; AVIGO, VUSE, VUSE CONNECT, VUSE FOB, VUSE HYBRID, ALTO, ALTO+, MODO, CIRO, FOX+FOG, AND SOLO+ by R. J. Reynolds Vapor Company; MISTIC MENTHOL by Mistic Ecigs; and VYPE by CN Creative Ltd. Yet other electrically powered aerosol delivery devices, and in particular those devices that have been characterized as so-called electronic cigarettes, have been marketed under the tradenames COOLER VISIONS™; DIRECT E-CIG™; DRAGONFLY™; EMIST™; EVERSMOKE™; GAMUCCI®; HYBRID FLAME™; KNIGHT STICKS™; ROYAL BLUES™; SMOKETIP®; SOUTH BEACH SMOKE™.

Additional manufacturers, designers, and/or assignees of components and related technologies that may be employed in the aerosol delivery device of the present disclosure include Shenzhen Jieshibo Technology of Shenzhen, China; Shenzhen First Union Technology of Shenzhen City, China; Safe Cig of Los Angeles, CA; Janty Asia Company of the Philippines; Joyetech Changzhou Electronics of Shenzhen, China; SIS Resources; B2B International Holdings of Dover, DE; Evolv LLC of OH; Montrade of Bologna, Italy; Shenzhen Bauway Technology of Shenzhen, China; Global Vapor Trademarks Inc. of Pompano Beach, FL; Vapor Corp. of Fort Lauderdale, FL; Nemtra GMBH of Raschau-Markersbach, Germany, Perrigo L. Co. of Allegan, MI; Needs Co., Ltd.; Smokefree Innotec of Las Vegas, NV; McNeil AB of Helsingborg, Sweden; Chong Corp; Alexza Pharmaceuticals of Mountain View, CA; BLEC, LLC of Charlotte, NC; Gaitrend Sarl of Rohrbach-lès-Bitche, France; FeelLife Bioscience International of Shenzhen, China; Vishay Electronic BMGH of Selb, Germany; Shenzhen Smaco Technology Ltd. of Shenzhen, China; Vapor Systems International of Boca Raton, FL; Exonoid Medical Devices of Israel; Shenzhen Nowotech Electronic of Shenzhen, China; Minilogic Device Corporation of Hong Kong, China; Shenzhen Kontle Electronics of Shenzhen, China, and Fuma International, LLC of Medina, OH, 21st Century Smoke of Beloit, WI, and Kimree Holdings (HK) Co. Limited of Hong Kong, China.

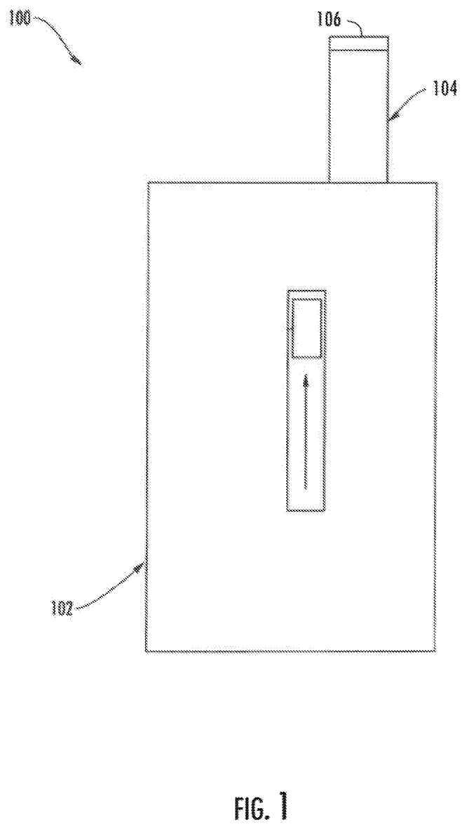

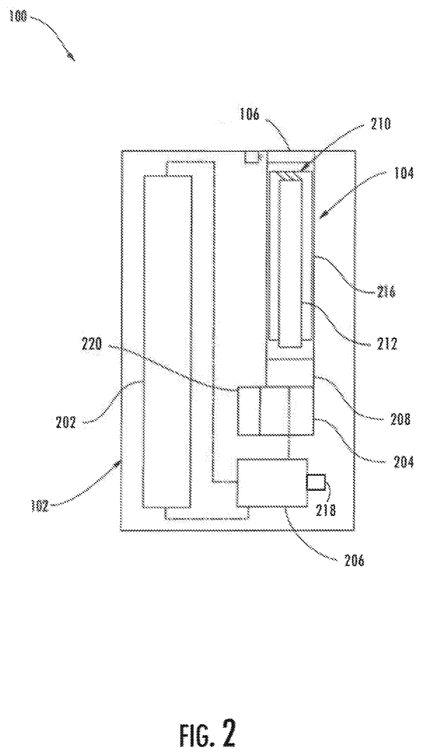

FIG. 1 illustrates a front view of an aerosol delivery device 100, and FIG. 2 illustrates a modified sectional view through the aerosol delivery device, according to an example implementation of the present disclosure. As illustrated, the aerosol delivery device may comprise a housing defining a control body 102 and a cartridge 104. The cartridge may be moveable with respect to at least a portion of, or an entirety of, the housing. In particular, the cartridge may be moveable relative to at least a portion of the housing between an extended configuration illustrated in FIG. 1, and a retracted configuration illustrated in FIG. 2. Details with respect to the mechanisms and manners associated with movement of the cartridge relative to the housing are described hereinafter.

In some example implementations, either or both of the control body 102 and the cartridge 104 of the aerosol delivery device 100 may be referred to as being disposable or as being reusable. The aerosol delivery device may include various other components disposed within the control body or the cartridge or otherwise coupled thereto. These components may be distributed between the control body and the cartridge in any of various manners. For example, the cartridge may include a replaceable battery or a rechargeable battery and thus may be combined with any type of recharging technology, including connection to a wall charger, connection to a car charger (i.e., a cigarette lighter receptacle), connection to a computer, such as through a universal serial bus (USB) cable or connector, connection to a photovoltaic cell (sometimes referred to as a solar cell) or a solar panel of solar cells. Further, in some example implementations, the cartridge may comprise a single-use cartridge, as disclosed in U.S. Pat. No. 8,910,639 to Chang et al., which is incorporated herein by reference in its entirety. Accordingly, it should be understood that the described implementations are provided for example purposes only.

As illustrated in FIG. 1, the cartridge 104 may include a mouthpiece 106 that may be exposed when the cartridge is in the extended configuration. In other words, the mouthpiece may be positioned outside of the control body housing 102 when the cartridge is in the extended configuration such that a user may engage the mouthpiece with his or her lips. Thus, the extended configuration of the cartridge is a configuration in which the aerosol delivery device 100 is configured to receive a draw on the mouthpiece such that the aerosol delivery device may produce and deliver an aerosol to a user in the manner described above.

In one example implementation, the control body 102 and cartridge 104 forming the aerosol delivery device 100 may be permanently coupled to one another. Examples of aerosol delivery devices that may be configured to be disposable and/or which may include first and second outer bodies that are configured for permanent coupling are disclosed in U.S. patent application Ser. No. 14/170,838 to Bless et al., filed Feb. 3, 2014, which is incorporated herein by reference in its entirety. In another example implementation, the control body and cartridge may be configured in a single-piece, non-detachable form and may incorporate the components, aspects, and features disclosed herein. However, in another example implementation, the control body and cartridge may be configured to be separable such that, for example, the cartridge may be refilled or replaced.

By way of example, in the illustrated implementation of FIG. 2, the aerosol delivery device 100 includes a power source 202 positioned within the control body 102. The power source may include, for example, a battery (single-use or rechargeable), solid-state battery, thin-film solid-state battery, supercapacitor or the like, or some combination thereof. Some examples of a suitable power source are provided in U.S. patent application Ser. No. 14/918,926 to Sur et al., filed Oct. 21, 2015, which is incorporated by reference. Further, a connector 204 may be moveably attached to the housing. The cartridge 104 may be engaged with the connector so as to be moveable relative to at least a portion of the control body housing. In some implementations, the cartridge may be removably engaged with the connector and replaceable.

The control body 102 of the aerosol delivery device 100 may additionally include a control component 206 received therein. As further shown in FIG. 2, in addition to the mouthpiece 106, the cartridge may include a base 208, atomizer 210, reservoir 212, and an outer body 216, in which the cartridge is coupled to the control body at the base. The cartridge also may include one or more electronic components, which may include an integrated circuit, a memory component, a sensor, a resistor (e.g., resistance temperature detector (RTD), or the like. The electronic components may be adapted to communicate with the control component 206 and/or with an external device by wired or wireless means. The electronic components may be positioned anywhere within the cartridge or the base 208 thereof.

The control component 206 of the control body 102 may be configured to direct electrical power from the power source 202 to the cartridge 104 to heat the aerosol precursor composition retained in the reservoir 212 with the atomizer 210 to produce a vapor, which may occur during a user draw on the mouthpiece 106 of the cartridge. The control component includes a number of electronic components, and in some examples may be formed of a printed circuit board (PCB) that supports and electrically connects the electronic components. Examples of suitable electronic components include a microprocessor or processor core, an integrated circuit (IC), a memory, and the like. In some examples, the control component may include a microcontroller with an integrated processor core and memory, and which may further include one or more integrated input/output peripherals.

In some examples, the control body 102 may include a communication interface 218 that may be included on a PCB of the control component 206, or a separate PCB that may be coupled to the PCB or one or more components of the control component. The communication interface may enable the aerosol delivery device 100 to wirelessly communicate with one or more networks, computing devices or other appropriately-enabled devices such as a suitable remote user interface. Examples of suitable computing devices include any of a number of different mobile computers. More particular examples of suitable mobile computers include portable computers (e.g., laptops, notebooks, tablet computers), mobile phones (e.g., cell phones, smartphones), wearable computers (e.g., smartwatches) and the like. In other examples, the computing device may be embodied as other than a mobile computer, such as in the manner of a desktop computer, server computer or the like. Examples of suitable manners according to which the aerosol delivery device may be configured to wirelessly communicate are disclosed in U.S. patent application Ser. No. 14/327,776, filed Jul. 10, 2014, to Ampolini et al., and U.S. patent application Ser. No. 14/609,032, filed Jan. 29, 2016, to Henry, Jr. et al., each of which is incorporated herein by reference in its entirety.

The communication interface 218 may provide for transmitting and receiving data through, for example, a wired or wireless network such as a local area network (LAN), a metropolitan area network (MAN), and/or a wide area network (WAN), for example, the Internet. The communication interface may enable the control component 206 to communicate with one or more further computing devices, either directly, or via the network. In this regard, the communication interface may include one or more interface mechanisms for enabling communication with other devices and/or networks.

The communication interface 218 may include, for example, an antenna (or multiple antennas) and supporting hardware and/or software for enabling wireless communication with a communication network (e.g., a cellular network, Wi-Fi, WLAN, and/or the like), and/or for supporting device-to-device, short-range communication, in accordance with a desired communication technology. Examples of suitable short-range communication technologies that may be supported by the communication interface include various near field communication (NFC) technologies, wireless personal area network (WPAN) technologies and the like. More particular examples of suitable WPAN technologies include those specified by IEEE 802.15 standards or otherwise, including Bluetooth, Bluetooth low energy (Bluetooth LE), ZigBee, infrared (e.g., IrDA), radio-frequency identification (RFID), Wireless USB and the like. Yet other examples of suitable short-range communication technologies include Wi-Fi Direct, as well as certain other technologies based on or specified by IEEE 802.11 and/or IEEE 802.15.4 standards and that support direct device-to-device communication.

As noted above, the cartridge 104 may be moveable relative to the control body housing 102. In this regard, the aerosol delivery device 100 may further comprise an actuator 220. In particular, the actuator may be coupled to the connector 204. Thereby, the actuator may be operatively engaged with the cartridge and configured to move the cartridge between the extended configuration and the retracted configuration.

As indicated above, in FIG. 1, the mouthpiece 106 may be exposed when the cartridge 104 is in the extended configuration. Conversely, as illustrated in FIG. 2, in the retracted configuration, the mouthpiece is relatively closer to the control body housing 102 than in the extended configuration of FIG. 1. In the retracted configuration, the mouthpiece may be flush with respect to the housing. In other words, an outer surface of the mouthpiece may substantially align with an outer surface of the housing. In another implementation the mouthpiece may be recessed with respect to the housing. In other words, a gap may be provided between the outer surface of the mouthpiece and the outer surface of the housing.

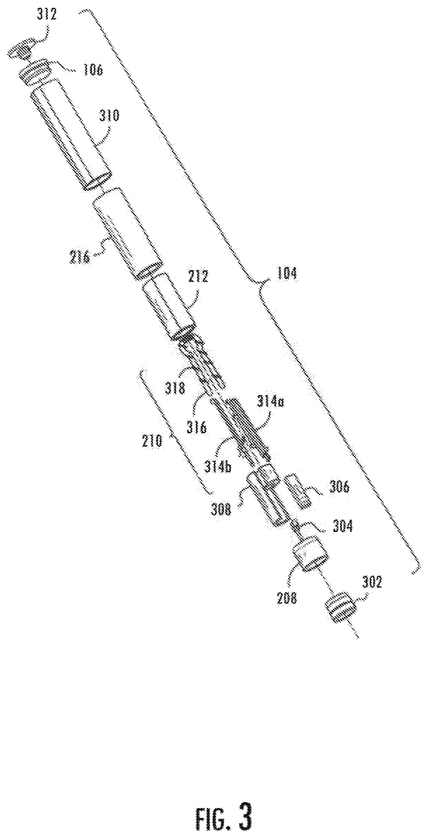

FIG. 3 illustrates a more particular example of the cartridge 104 of FIGS. 1 and 2. As illustrated, in addition to the mouthpiece 106, base 208, atomizer 210, reservoir 212, and outer body 216, the cartridge may also comprise a base shipping plug 302, a control component terminal 304, an electronic control component 306, a flow tube 308, a label 310, and a mouthpiece shipping plug 312 according to an example implementation of the present disclosure. In various configurations, this structure may be referred to as a tank; and accordingly, the terms “cartridge,” “tank” and the like may be used interchangeably to refer to a shell or other housing enclosing a reservoir for aerosol precursor composition, and including a heater.

The base 208 may be coupled to a first end of the outer body 216, and the mouthpiece 106 may be coupled to an opposing second end of the outer body, to at least partially enclose the remaining components of the cartridge 104 therein, with the exception of the label 310, the mouthpiece shipping plug 312, and the base shipping plug 302. The base may be configured to engage an associated device including the power source 202. In some implementations, the base may comprise anti-rotation features that substantially prevent relative rotation between the cartridge and associated device including the power source. The base shipping plug may be configured to engage and protect the base prior to use of the cartridge. Similarly, the mouthpiece shipping plug may be configured to engage and protect the mouthpiece prior to use of the cartridge.

The control component terminal 304, the electronic control component 306, the flow tube 308, the atomizer 210, and the reservoir substrate 212 may be retained within the outer body 216. The label 310 may at least partially surround the outer body and include information such as a product identifier thereon. The atomizer 210 may comprise a first heating terminal 314a and a second heating terminal 314b, a liquid transport element 316 and a heating element 318 which may in some examples be or include a resistance temperature detector (RTD).

In some examples, a valve may be positioned between the reservoir and the heating element, and configured to control an amount of aerosol precursor composition passed or delivered from the reservoir to the heating element.

The reservoir 212 may be a container or can be a fibrous reservoir, as presently described. For example, the reservoir may comprise one or more layers of nonwoven fibers substantially formed into the shape of a tube encircling the interior of the cartridge 104. An aerosol precursor composition can be retained in the reservoir. Liquid components, for example, can be sorptively retained by the reservoir. The reservoir can be in fluid connection with the liquid transport element 316 adapted to wick or otherwise transport an aerosol precursor composition stored in the reservoir housing to the heating element 318. In particular, the liquid transport element can transport the aerosol precursor composition stored in the reservoir via capillary action to the heating element that is in the form of a metal wire coil in this example. As such, the heating element is in a heating arrangement with the liquid transport element.

In some examples, a microfluidic chip may be embedded in the reservoir 212, and the aerosol precursor composition in the reservoir may be controlled by a micro pump, such as one based on microelectromechanical systems (MEMS) technology. The heating element 318 may be configured to implement radio-frequency inductive based heating of the aerosol precursor composition without a wick or physical contact with the aerosol precursor composition, such as in a manner described in U.S. patent application Ser. No. 14/934,763 to Davis et al., filed Nov. 6, 2015, which is incorporated by reference. Other example implementations of reservoirs and transport elements useful in aerosol delivery devices according to the present disclosure are further described below, and such reservoirs and/or transport elements can be incorporated into devices such as illustrated in FIG. 3 as described herein. In particular, specific combinations of heating members and transport elements as further described below may be incorporated into devices such as illustrated in FIG. 3 as described herein.

Various examples of materials configured to produce heat when electrical current is applied therethrough may be employed to form the heating element 318. The heating element in these examples may be resistive heating element such as a wire coil. Example materials from which the wire coil may be formed include Platinum (Pt) and Pt alloys, Titanium (Ti) and Ti alloys, Copper (Cu) and Cu alloys, Nickel (Ni) and Ni alloys, Kanthal (FeCrAl), Nichrome, Molybdenum disilicide (MoSi₂), molybdenum silicide (MoSi), Molybdenum disilicide doped with Aluminum (Mo(Si,Al)₂), graphite and graphite-based materials (e.g., carbon-based foams and yarns) and ceramics (e.g., positive or negative temperature coefficient ceramics). Example implementations of heating elements or heating members useful in aerosol delivery devices according to the present disclosure are further described below, and can be incorporated into devices such as illustrated in FIG. 3 as described herein.

The cartridge 104 may include a flow director defining a non-tubular configuration, an electronics compartment sealed with respect to a reservoir compartment, and/or any of the various other features and components disclosed therein. Accordingly, it should be understood that the particular implementation of the cartridge described herein is provided for example purposes only. In this regard, the cartridge is schematically illustrated in FIG. 2 as including only the mouthpiece 106, the outer body 216, the atomizer 210, the reservoir 212, and the base 208, in light of the various alternate and additional components that may be included therein.

One or more components of the cartridge 108 may be configured to form an electrical connection with the connector 204. For example, referring to the cartridge implementation of FIG. 3, the first heating terminal 314a and the second heating terminal 314b (e.g., positive and negative terminals) at the opposing ends of the heating element 318 are configured to form an electrical connection with the connector. Further, the electronic control component 306 (see FIG. 3) may form an electrical connection with the connector through the control component terminal 304 (see FIG. 3). Components within the control body 102 (e.g., the control component 206) may thus employ the electronic control component to determine whether the cartridge is genuine and/or perform other functions. However, in other implementations the connection between the connector and the cartridge may not be electrical. In other words, the connection between the connector and the cartridge may be purely mechanical. In these implementations, atomization may occur outside of the cartridge or atomization may occur via other methods not requiring electrical connections between the cartridge and the housing such as via piezoelectric or radio frequency atomization. Alternatively, the power source may be positioned in the cartridge such that electrical connection with connector is not required.

In use, when a user draws on the aerosol delivery device 100, the heating element 318 of the atomizer 210 is activated to vaporize components of the aerosol precursor composition. Drawing upon the mouthpiece 106 of the aerosol delivery device causes ambient air to enter and pass through an opening in the connector 204 or in the cartridge 104. In the cartridge, the drawn air combines with the formed vapor to form an aerosol. The aerosol is whisked, aspirated or otherwise drawn away from the heating element and out the opening in the mouthpiece of the aerosol delivery device. However, the flow of air may be received through other parts of the aerosol delivery device in other implementations. As noted above, in some implementations the cartridge may include the flow tube 308. The flow tube may be configured to direct the flow of air to the heating element.

In particular, a sensor in the aerosol delivery device 100 may detect the flow of air throughout the aerosol delivery device. When a flow of air is detected, the control component 206 may direct current to the heating element 318 through a circuit including the first heating terminal 314a and the second heating terminal 314b. Accordingly, the heating element may vaporize the aerosol precursor composition directed to an aerosolization zone from the reservoir 212 by the liquid transport element 316. Thus, the mouthpiece 106 may allow passage of aerosol (i.e., the components of the aerosol precursor composition in an inhalable form) therethrough to a consumer drawing thereon. In some examples, in which the heating element is or includes a resistance temperature detector (RTD), the RTD may be used to provide an optimal temperature for specific e-liquids. For example, the aerosol precursor composition within a cartridge 104 may have a particular flavor in which information indicating the flavor type is stored within memory of the cartridge (e.g., stored on a microchip). The information may be utilized to determine (or “read”) the flavor of the aerosol precursor composition within the cartridge, and a value of the RTD may be adjusted to provide an optimal temperature for that specific flavor.

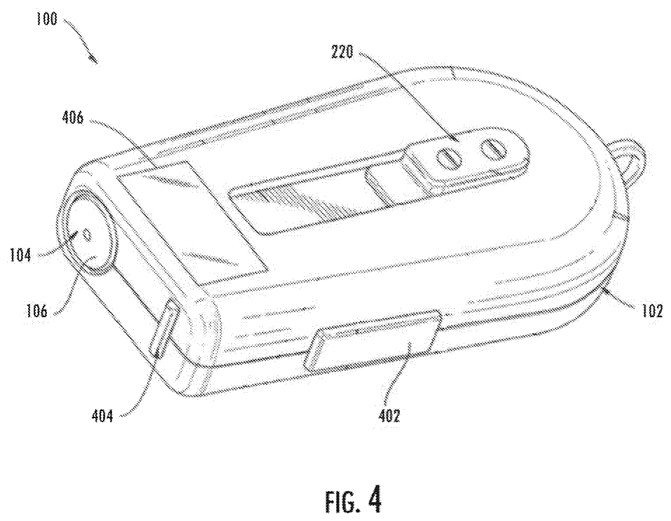

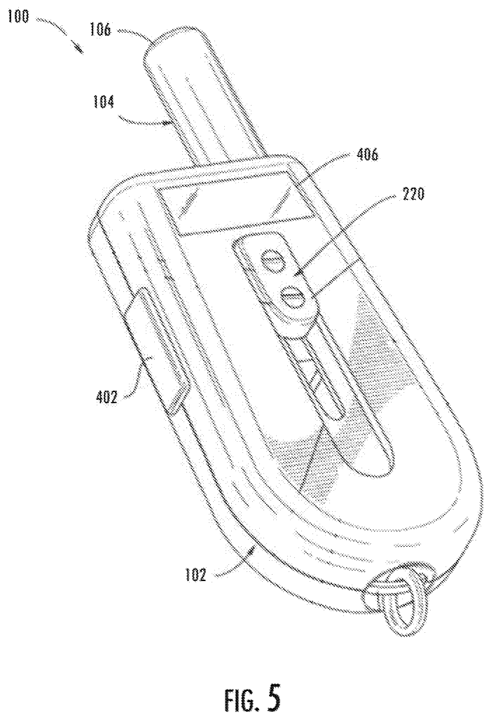

FIG. 4 illustrates a perspective view of the aerosol delivery device 100 in the closed configuration, and FIG. 5 illustrates a perspective view of the aerosol delivery device in the extended configuration, having a particular form factor according to some example implementations. As illustrated, the housing of the control body 102 may define an ergonomic shape configured to comfortably fit within a user's hand. The shape of the housing, however, is not limited and may be any shape that accommodates the various elements as described herein. In some implementations, the housing may be expressly non-cylindrical.

As illustrated in FIG. 4, the aerosol delivery device 100 may additionally include an input mechanism 402 configured to receive an input from a user. The input mechanism may take a variety of forms, such as a pushbutton, keypad, dial, touch screen, audio input interface, visual/image capture input interface, input in the form of sensor data, and the like. When the input mechanism is actuated, the aerosol delivery device may produce an output corresponding to a status of the aerosol delivery device. For example, the aerosol delivery device may output sound, vibration, or light. The aerosol delivery device may further comprise an indicator 404. The indicator may comprise a light transmitter (e.g., plastic or glass, which may be tinted a desired color). Further, the indicator may include a light emitter, which may comprise an incandescent bulb or light emitting diode (LED). Thereby, the light emitter may illuminate the light transmitter, which may direct the light outwardly therethrough to output a status of the aerosol delivery device.

The indicator 404 may flash or otherwise illuminate to indicate a remaining or used portion of the capacity of the power source 206 or the reservoir 212. For example, a relatively large number of flashes of the indicator upon actuation of the input mechanism 402 may correspond to a relatively large remaining capacity of the power source or the reservoir. Conversely, a relatively small number of flashes of the indicator upon actuation of the input mechanism may correspond to a relatively small remaining capacity of the power source or the reservoir. However, the indicator and/or other output mechanisms may be employed to output various other information and/or output information in various other manners. Examples of other information that may be outputted include error messages, operational modes, historical usage information, etc.

In some implementations, the aerosol delivery device 100 may include a display 406, as illustrated in FIGS. 4 and 5. The display may be provided in addition to, or as an alternate for, the indicator 404. The display may be configured to output various information including information regarding a status of the aerosol delivery device, information unrelated to the status of the aerosol delivery device (e.g., the present time), and/or non-informative graphics (e.g., graphics provided for user entertainment purposes). Thereby, the display may be configured to output any or all of the information described above (e.g., a remaining or used portion of the capacity of the power source 206 or the reservoir 212, or a temperature of the heating element 318) in any form such as graphical form and/or a numerical form.

Further, in some implementations operation of the display 406 may be controlled by the input mechanism 402 or a separate input mechanism. The display, for example, may be a touchscreen and thus may be configured for user input. In some implementations, the display may provide icons, menus, or the like configured to allow a user to make control selections related to the functioning of the aerosol delivery device, check a specific status of the device, or the like. Although the display is illustrated as encompassing only a relatively small portion of the aerosol delivery device, it is understood that the display may cover a significantly greater portion of the aerosol delivery device.

The various components of an aerosol delivery device according to the present disclosure can be chosen from components described in the art and commercially available. Examples of batteries that can be used according to the disclosure are described in U.S. Pat. App. Pub. No. 2010/0028766 to Peckerar et al., which is incorporated herein by reference in its entirety.

The aerosol delivery device 100 can incorporate the flow sensor or another sensor or detector for control of supply of electric power to the heating element 318 when aerosol generation is desired (e.g., upon draw during use). As such, for example, there is provided a manner or method of turning off the power supply to the heating element when the aerosol delivery device is not be drawn upon during use, and for turning on the power supply to actuate or trigger the generation of heat by the heating element during draw. Additional representative types of sensing or detection mechanisms, structure and configuration thereof, components thereof, and general methods of operation thereof, are described in U.S. Pat. No. 5,261,424 to Sprinkel, Jr., U.S. Pat. No. 5,372,148 to McCafferty et al., and PCT Pat. App. Pub. No. WO 2010/003480 to Flick, all of which are incorporated herein by reference in their entireties.

The aerosol delivery device 100 most preferably incorporates the control component 206 or another control mechanism for controlling the amount of electric power to the heating element 318 during draw. Representative types of electronic components, structure and configuration thereof, features thereof, and general methods of operation thereof, are described in U.S. Pat. No. 4,735,217 to Gerth et al., U.S. Pat. No. 4,947,874 to Brooks et al., U.S. Pat. No. 5,372,148 to McCafferty et al., U.S. Pat. No. 6,040,560 to Fleischhauer et al., U.S. Pat. No. 7,040,314 to Nguyen et al., U.S. Pat. No. 8,205,622 to Pan, U.S. Pat. App. Pub. No. 2009/0230117 to Fernando et al., U.S. Pat. App. Pub. No. 2014/0060554 to Collet et al., U.S. Pat. App. Pub. No. 2014/0270727 to Ampolini et al., and U.S. patent application Ser. No. 14/209,191 to Henry et al., filed Mar. 13, 2014, all of which are incorporated herein by reference in their entireties.

Representative types of substrates, reservoirs or other components for supporting the aerosol precursor are described in U.S. Pat. No. 8,528,569 to Newton, U.S. Pat. App. Pub. No. 2014/0261487 to Chapman et al., U.S. Pat. App. Pub. No. 2015/0059780 to Davis et al., filed Aug. 28, 2013, and U.S. patent application Ser. No. 14/170,838 to Bless et al., filed Feb. 3, 2014, all of which are incorporated herein by reference in their entireties. Additionally, various wicking materials, and the configuration and operation of those wicking materials within certain types of electronic cigarettes, are set forth in U.S. Pat. App. Pub. No. 2014/0209105 to Sears et al., which is incorporated herein by reference in its entirety.

The aerosol precursor composition, also referred to as a vapor precursor composition, may comprise a variety of components including, by way of example, a polyhydric alcohol (e.g., glycerin, propylene glycol or a mixture thereof), nicotine, tobacco, tobacco extract and/or flavorants. Representative types of aerosol precursor components and formulations also are set forth and characterized in U.S. Pat. No. 7,217,320 to Robinson et al. and U.S. Pat. Pub. Nos. 2013/0008457 to Zheng et al.; 2013/0213417 to Chong et al.; 2014/0060554 to Collett et al.; 2015/0020823 to Lipowicz et al.; and 2015/0020830 to Koller, as well as WO 2014/182736 to Bowen et al, the disclosures of which are incorporated herein by reference. Other aerosol precursors that may be employed include the aerosol precursors that have been incorporated in the VUSE® product by R. J. Reynolds Vapor Company, the BLU™ product by Imperial Brands PLC, the MISTIC MENTHOL product by Mistic Ecigs, and the VYPE product by CN Creative Ltd. Also desirable are the so-called “smoke juices” for electronic cigarettes that have been available from Johnson Creek Enterprises LLC.

Additional representative types of components that yield visual cues or indicators may be employed in the aerosol delivery device 100, such as LEDs and related components, auditory elements (e.g., speakers), vibratory elements (e.g., vibration motors) and the like. Examples of suitable LED components, and the configurations and uses thereof, are described in U.S. Pat. No. 5,154,192 to Sprinkel et al., U.S. Pat. No. 8,499,766 to Newton, U.S. Pat. No. 8,539,959 to Scatterday, and U.S. patent application Ser. No. 14/173,266 to Sears et al., filed Feb. 5, 2014, all of which are incorporated herein by reference in their entireties.

Yet other features, controls or components that can be incorporated into aerosol delivery devices of the present disclosure are described in U.S. Pat. No. 5,967,148 to Harris et al., U.S. Pat. No. 5,934,289 to Watkins et al., U.S. Pat. No. 5,954,979 to Counts et al., U.S. Pat. No. 6,040,560 to Fleischhauer et al., U.S. Pat. No. 8,365,742 to Hon, U.S. Pat. No. 8,402,976 to Fernando et al., U.S. Pat. App. Pub. No. 2005/0016550 to Katase, U.S. Pat. App. Pub. No. 2010/0163063 to Fernando et al., U.S. Pat. App. Pub. No. 2013/0192623 to Tucker et al., U.S. Pat. App. Pub. No. 2013/0298905 to Leven et al., U.S. Pat. App. Pub. No. 2013/0180553 to Kim et al., U.S. Pat. App. Pub. No. 2014/0000638 to Sebastian et al., U.S. Pat. App. Pub. No. 2014/0261495 to Novak et al., U.S. Pat. App. Pub. No. 2014/0261408 to DePiano et al., and U.S. patent application Ser. No. 14/286,552 to Brinkley et al., all of which are incorporated herein by reference in their entireties.

In accordance with some example implementations of the present disclosure, the temperature of the aerosol delivery device 100, and more particularly the heating element 318, may be measured, displayed and/or controlled in real-time or near real-time (generally “real-time”). In these examples, accurate temperature feedback may be provided for a user. Further, the user may provide input through a wireless or on-board user interface for adjustment of the temperature. In these examples, the user may achieve a desired aerosol level based on the device temperature of the heating element without requiring explicit knowledge of the voltage, watts or ohms that are traditionally used as the basis for conveying such adjustments.

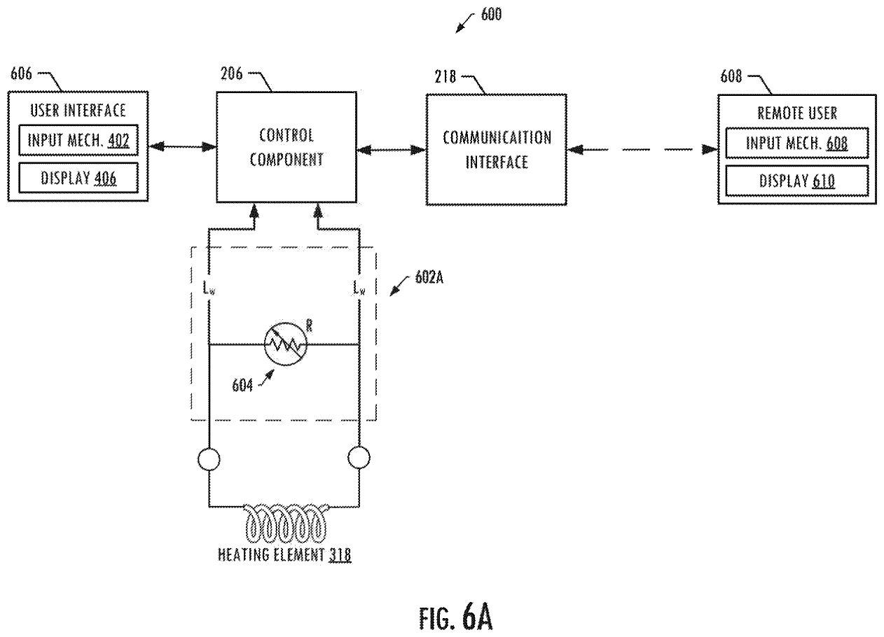

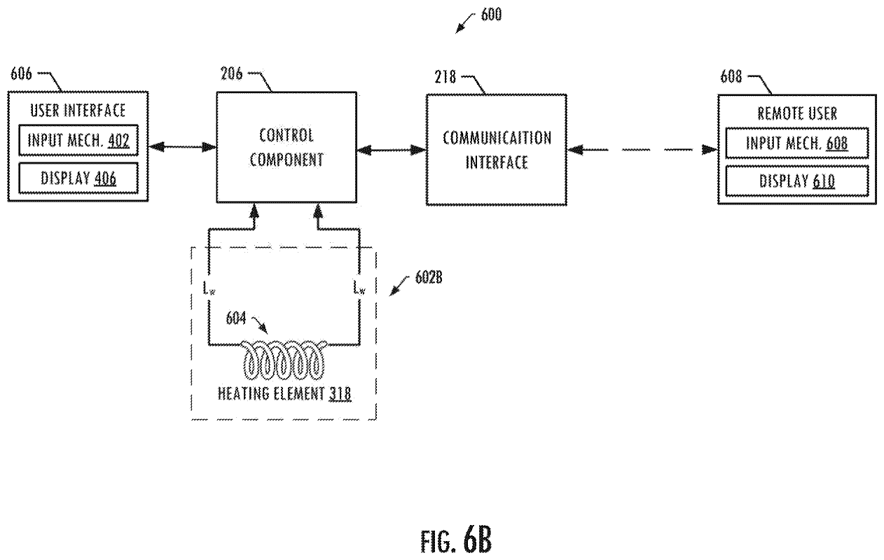

FIGS. 6A and 6B illustrate particular configurations of various electronic components 600 of the aerosol delivery device 100 that may be utilized for providing real-time display and/or control of the temperature of the heating element 318, according to some example implementations. For example, as shown, the aerosol delivery device may include a control component 206 operatively coupled to a RTD 602A, 602B to enable real-time measurement, and display and/or control of the heating element temperature.

In particular, the RTD 602A, 602B may have a resistance that is variable and proportional to a temperature of the heating element 318. The RTD may also have a temperature coefficient of resistance that is invariable with respect to the temperature of the heating element. Based at least in part of these properties, the control component 206 may be configured to measure the resistance of the RTD and therefrom determine the temperature of the heating element. The control component may then control a functional element of the aerosol delivery device 100 in real-time based on the determined temperature. It should be noted that although the example implementations herein are discussed with reference to the control component 206 of the control body 102, in some examples the functions of the control component may alternatively be executed by or in conjunction with the control component 306 of the cartridge 104.

The RTD 602A, 602B may generally include an RTD element 604 and lead wires L_{w} to couple the RTD element to a measuring instrument such as the control component 206. It should be noted that although the illustrated implementations depict the RTD having two lead wires, the RTD may alternatively include various other multiple lead wire configurations such as three lead wire and four lead wire configurations.

More particularly, FIGS. 6A and 6B illustrate a suitable RTD 602A, 602B according to some example implementations. In some examples, as shown in FIG. 6A, the RTD 602A may include an RTD element 604 such as a resistor R or sensing wire that may be operatively coupled to the heating element 318 for providing a measurable resistance that is variable and proportional to a temperature of the heating element. In some alternative examples, as shown in FIG. 6B, the RTD 602B may be integrated with the heating element 318 of the aerosol delivery device 100. In these examples, in addition to being configured to produce heat to vaporize components of the aerosol precursor composition, the heating element itself may be utilized as the RTD element or sensing wire for providing a direct measurable resistance for determining the temperature thereof.

In integrated examples (FIG. 6B), the heating element 318 utilized as the RTD element 604 may be formed of a metal that comprises a suitable intrinsic material property for providing a linear approximation of electrical resistance as a function of temperature. Examples of suitable metals include platinum (Pt), titanium (Ti), copper (Cu), nickel (Ni) or various alloys thereof. That is, the RTD element may be formed of a Pt, Ti, Cu or Ni alloy. The RTD element may also be formed of any other metal having a temperature coefficient of resistance (a) that is relatively large and does not substantially fluctuate as a function of temperature. The heating element may be utilized as the RTD element in implementations in which the heating element is formed from one of these suitable metals.

In some examples, the RTD element 604 may also have a temperature coefficient of resistance that is suitably large enough to maintain a change in resistance of the RTD 602A, 602B based on the processing speed of the control component 206. As used herein, a “suitably large enough” temperature coefficient of resistance may refer to a temperature coefficient of resistance having a predetermined value relative to the processing power of the control component (e.g., a microprocessor). For example, a control component that includes at least a 12-bit microprocessor may be necessary to achieve the resolution required for effecting a change in resistance of the RTD per degree Celsius. In this example, the temperature coefficient of resistance may be greater than, or equal to, 0.001 which may be sufficient for an 8 to 12-bit processor. In some examples, the faster the processing speed of the control component, the lower the required value of temperature coefficient of resistance may be such that the processing speed of the control component and the temperature coefficient of resistance are inversely proportional to one another. For example, in one implementation, the RTD element may be formed of Nichrome, and a high-speed microprocessor may be used in conjunction with the RTD element even though Nichrome has a minuscule temperature coefficient of resistance (e.g., 0.00017).

For metals, electrical resistance increases as function of temperature in which an inverse correlation may be observed for intrinsic semiconductors and carbon. For certain metals or elements such as platinum (Pt), titanium (Ti), copper (Cu) and nickel (Ni), as well at least some of the alloys thereof, the temperature coefficient of resistance is relatively large and invariable with respect to the temperature of the heating element, and thus remains relativity constant as the temperature increases. This property allows for a linear approximation of electrical resistance as a function of temperature in which the following relation is shown in equation (1), where Rₒ is the resistance at temperature Tₒ (the initial temperature of the heating element 318), α is the temperature coefficient of resistance, and R_{T} is the resistance at temperature T (the final temperature of the heating element):

$${R}_{T} = {R}_{0} [ 1 + α ( T - {T}_{0} ) ] \qquad ( 1 )$$

The accuracy of the RTD 602 in predicting or determining the temperature of the heating element 318 (e.g., atomizer) temperature, and thereby providing resistance-temperature feedback, will improve if the temperature coefficient of resistance (a) is experimentally quantified and employed over narrow temperature ranges. This a can then be hard-coded into the control component 206 (e.g., microcontroller) such that an algorithm can regulate the heating element temperature based off of real-time resistance values of the heating element. Predicted temperatures of the heating element over a given temperature range can be obtained via equation (2):

$$T = {T}_{0} + ( \frac{( \frac{R}{{R}_{0}} - 1 )}{α} ) \qquad ( 2 )$$

In any of these examples, the RTD 602A, 602B may be located within either the control body 102, or within the cartridge 104. In particular, in examples in which the RTD element 604 and the heating element 318 are separate and distinct components, the RTD may be located within the cartridge and operatively coupled to the control component 206 when the control body 102 and cartridge are engaged. Alternatively, the RTD may be located within the control body and operatively coupled to the heating element when the housing and cartridge are engaged.

Similarly, in instances in which the RTD element 604 and the heating element 318 are integrated, the RTD 602A, 602B may be located within the cartridge 104 and operatively coupled to the control component 206 when the control body 102 and cartridge are engaged. Further, in some examples, components of the RTD may be located within both the control body and the cartridge. For example, the RTD element may be located within the cartridge and the lead wires L_{w} may be connected to the RTD element and further extend into the control body for coupling the RTD element with the control component.

In some examples, the RTD 602A, 602B may be used in conjunction with pulse width modulation (PWM) to account for depleting power of the power source 104 in order to maintain a set temperature throughout the power cycle. The PWM may be driven by control component 206 (e.g., a microcontroller) and one or more algorithms executed thereby and used to streamline the power utilized for each puff. In some examples, a voltage of the power source 202 may steadily decline during a discharge thereof, and the power source may be configured to provide a duration of power for the usage of at least two cartridges 104. In this example, it is desirable for the voltage output, and thereby the temperature, for each puff from the first and second cartridge to remain constant the use of the cartridges. Thus the PWM may be configured such that the voltage output steadily increases for each increment of puffs. For example, in one implementation a first increment of puffs (e.g., 50 puffs) 70% voltage output, the next increment of puffs uses 75% voltage output, the next increment of puffs uses 80%-voltage output, and so forth until the last increment of puffs uses 100% voltage output. In this example, as the voltage of the power source declines during discharge, the 100% voltage output nearing the end of the discharge would effect the same voltage as the 70% voltage out from the fully charged power source.

As indicated above, the control component 206 may be configured to control a functional element of the aerosol delivery device 100 in real-time based on the determined temperature of the heating element 318. In these examples, control of the functional element may include output of the temperature for presentation by a display of a local or remote user interface, and/or adjustment of the power to the heating element. It should be noted that the control of the function element does not require an output of the temperature for presentation by the display in all instance. For example, in one implementation, the temperature may be hidden from, or otherwise not visible to, a user of the aerosol delivery device 100, and in this implementation the power may be adjusted to the heating element solely as a safety feature. Alternatively in some examples, the temperature may be visible to the user and the aerosol delivery device may include a user interface 606 that includes the input mechanism 402 and display 406 to enable user interaction with the aerosol delivery device. In some examples, the control component may be configured to receive a temperature-based setting from the user interface (e.g., via the input mechanism) and direct the power to the heating element in accordance with the temperature-based setting.

In addition to or in lieu of the user interface 606, in some examples, the temperature of the aerosol delivery device 100 may also be displayable on, and/or controllable based on a temperature-based setting provided by a remote user interface 608 that may include a suitable input mechanism 608 and display 610. In these examples, the aerosol delivery device may also include a communication interface 612 to enable communication with the remote user interface, and thereby enable presentation and control of the temperature by the remote user interface. For example, the aerosol delivery device may be configured to wirelessly communicate with the remote user interface, indirectly via one or more networks, according to some example implementations of the present disclosure.

In some implementations, the remote user interface 612 may be that of a remote computing device. Examples of suitable computing devices include any of a number of different mobile computers. More particular examples of suitable mobile computers include portable computers (e.g., laptops, notebooks, and tablet computers), mobile phones (e.g., cell phones, smartphones), wearable computers (e.g., smartwatches) and the like. In other examples, the computing device may be embodied as other than a mobile computer, such as in the manner of a desktop computer, server computer or the like.

Examples of suitable manners according to which the aerosol delivery device may be configured to wirelessly communicate with a remote computing device including the remote user interface 612 are disclosed in U.S. patent application Ser. No. 14/327,776, filed Jul. 10, 2014, to Ampolini et al., and U.S. patent application Ser. No. 14/609,032, filed Jan. 29, 2016, to Henry, Jr. et al., each of which is incorporated herein by reference in its entirety.

In these examples, control of the functional element of the aerosol delivery device 100 may include output of the temperature for presentation by the remote display 612 in which the communication interface 608 may be coupled to the control component 206 and configured to enable wireless communication of the temperature to the remote display. Similarly, the communication interface may be coupled to the control component and configured to enable wireless communication of the temperature-based setting from the remote user interface 608 (e.g., via remote input mechanism 610).

The foregoing description of use of the article(s) can be applied to the various example implementations described herein through minor modifications, which can be apparent to the person of skill in the art in light of the further disclosure provided herein. The above description of use, however, is not intended to limit the use of the article but is provided to comply with all necessary requirements of disclosure of the present disclosure. Any of the elements shown in the article(s) illustrated in FIGS. 1-6A and 6B or as otherwise described above may be included in an aerosol delivery device according to the present disclosure.

Many modifications and other implementations of the disclosure set forth herein will come to mind to one skilled in the art to which this disclosure pertains having the benefit of the teachings presented in the foregoing descriptions and the associated drawings. Therefore, it is to be understood that the disclosure is not to be limited to the specific implementations disclosed, and that modifications and other implementations are intended to be included within the scope of the appended claims. Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A cartridge for an aerosol delivery device comprising:
a housing and at least partially disposed within the housing:
a reservoir configured to retain an aerosol precursor composition;
an atomizer controllable to activate and vaporize components of the aerosol precursor composition;
a memory configured to store product information therein, wherein the cartridge is configured to communicate the product information to enable control of the atomizer.

2. The cartridge of claim 1, further comprising a communication interface configured to communicate the product information for control of the atomizer.

3. The cartridge of claim 2, wherein the communication interface is configured to wirelessly communicate with a remote computing device for control of the atomizer.

4. The cartridge of claim 1, wherein the cartridge is further configured to be coupled with a control body to form an aerosol delivery device, the control body comprising a communication interface configured to communicate the product information and a control component in communication therewith, the control component configured to control the atomizer based on the product information communicated thereto.

5. The cartridge of claim 1, wherein the product information comprises an ingredient of the aerosol precursor composition.

6. The cartridge of claim 1, wherein the product information comprises flavor information and the atomizer is controlled to provide an optimal temperature for a particular flavor, wherein the optimal temperature is a temperature at which the particular flavor is provided in an inhalable state.

7. The cartridge of claim 4, wherein the cartridge housing is configured to be moveably coupled to the control body.

8. The cartridge of claim 7, further comprising an actuator operatively engaged with the cartridge housing and configured to move the cartridge housing between an extended configuration and a retracted configuration relative to the control body.

9. The cartridge of claim 8, further comprising an electrical connector disposed within the control body and configured to electrically connect the cartridge housing and the control body, wherein the cartridge housing is configured to be moveably coupled to the control body via the electrical connector coupled to the actuator.

10. An aerosol delivery device comprising:
a cartridge including a housing and at least partially disposed within the cartridge housing:
a reservoir configured to retain an aerosol precursor composition;
an atomizer controllable to activate and vaporize components of the aerosol precursor composition;
a memory configured to store product information therein; and
a communication interface configured to communicate the product information for control of the atomizer.

11. The aerosol delivery device of claim 10, further comprising a control body, the control body comprising a housing and contained within the control housing:
a control component configured to control operation of the atomizer based on the product information communicated thereto; and
the communication interface coupled to the control component and configured to enable wireless communication.

12. The aerosol delivery device of claim 10, wherein the communication interface is configured to wirelessly communicate with a remote computing device for control of the atomizer.

13. The aerosol delivery device of claim 10, wherein the product information comprises flavor information and the atomizer is controlled to provide an optimal temperature for a particular flavor, wherein the optimal temperature is a temperature at which the particular flavor is provided in an inhalable state.

14. The aerosol delivery device of claim 11, wherein the control component is further configured to control at least one other functional element of the aerosol delivery device.

15. The aerosol delivery device of claim 11, further comprising a user interface.

16. The aerosol delivery device of claim 15, wherein the user interface is a remote user interface and the communication interface is configured to enable wireless communication of a user input from the remote user interface to the control body.

17. The aerosol delivery device of claim 11, wherein the cartridge housing is configured to be moveably coupled to the control housing.

18. The aerosol delivery device of claim 17, further comprising an actuator operatively engaged with the cartridge housing and configured to move the cartridge housing between an extended configuration and a retracted configuration relative to the control housing.

19. The aerosol delivery device of claim 18, further comprising an electrical connector configured to electrically connect the cartridge housing and the control body, wherein the cartridge housing is configured to be moveably coupled to the control housing via the electrical connector coupled to the actuator.
